(19) United States
(12) Patent Application Publication
(10) Pub. No.: US 2022/0392472 A1
(43) Pub. Date: Dec. 8, 2022

(54) AUDIO SIGNAL PROCESSING DEVICE, AUDIO SIGNAL PROCESSING METHOD, AND STORAGE MEDIUM

(71) Applicant: NEC Corporation, Minato-ku, Tokyo (JP)

(72) Inventor: Takayuki ARAKAWA, Tokyo (JP)

(73) Assignee: NEC Corporation, Minato-ku, Tokyo (JP)

(21) Appl. No.: 17/761,643

(22) PCT Filed: Sep. 27, 2019
(86) PCT No.: PCT/JP2019/038200

§ 371 Date: Mar. 18, 2022

(51) Int. Cl. G10L 21/0216; G10L 21/028; G10L 25/78

(52) U.S. Cl. CPC G10L 21/0216; G10L 21/028; G10L 25/78; G10L 2021/02087

(57) ABSTRACT

An audio signal processing device comprises: a determination unit that determines a first voice segment for a target speaker linked to a host device on the basis of an externally acquired first audio signal; a sharing unit that transmits the first audio signal and the first voice segment to another device linked to a non-target speaker and receives a second audio signal and a second voice segment associated with the non-target speaker from the other device; an estimation unit that estimates the voice of the non-target speaker mixed in the first audio signal on the basis of the second audio signal and the second voice segment that are received and an estimation parameter associated with the target speaker that is acquired; and a removal unit that removes the voice of the non-target speaker from the first audio signal.

### TECHNICAL FIELD

The disclosure relates to an audio signal processing device and the like for emphasizing a voice of a specific speaker among a plurality of speakers.

### BACKGROUND ART

Voice is a natural communication means for humans, and not only communication between humans in the same place but also communication with humans in different places is implemented using voice as a medium using a telephone, a web conference system, or the like. In addition, it is becoming possible for a system to understand human voice using a voice recognition technique, and voice communication has been implemented not only between humans but also between humans and the system.

In such communication using voice, a technique that emphasizes a voice of a specific speaker in a mixture of a plurality of speakers and facilitates listening to the voice has been developed. This technique can be used in various scenes. For example, in a web conference system, the voice of the speaker who is mainly speaking is emphasized to reduce the influence of surrounding noise, so that the speech of the speaker can be easily heard. Furthermore, in a voice recognition system, highly accurate voice recognition can be implemented by inputting a voice separated for each speaker instead of inputting mixed voices.

Techniques for emphasizing the voice of a specific speaker are as follows.

PTL 1 discloses a technique of performing sound source localization for estimating a direction of a speaker using a plurality of microphones and emphasizing a voice coming from the direction of the speaker estimated by the sound source localization (beam forming processing).

PTL 2 discloses a technique in which an ad-hoc network is formed by a plurality of terminals including a microphone, sound signals recorded in the plurality of terminals are transmitted and received with each other and shared, and time shifts of voices recorded in the respective terminals are corrected and added to emphasize only the voice of a specific speaker from the plurality of sound signals.

In addition, PTL 3 discloses a technique of determining a voice section, related to the above technique.

### CITATION LIST

### Patent Literature

[PTL 1] JP 2002-091469 A
[PTL 2] JP 2011-254464 A
[PTL 3] JP 5299436 B

### SUMMARY OF INVENTION

### Technical Problem

Since the voice attenuates as the distance increases, it is desirable that the distance between the mouth of the speaker who emits the voice and the microphone that receives the voice is as close as possible. In particular, it is known that the higher the frequency, the faster the attenuation, and not only the voice becomes more susceptible to surrounding noise due to the increase in distance, but also the frequency characteristic of the voice changes.

In PTL 1, the voice is emphasized using the plurality of microphones (for example, a microphone array device) whose positions are fixed. However, the microphone cannot be brought close to each speaker, and is affected by surrounding noise.

In PTL 2, since the independent terminals including a microphone form an ad-hoc network, the microphone can be brought close to each speaker. However, in the technique disclosed in PTL 2, in a case where a plurality of speakers simultaneously talks or talks with an insufficient time interval between conversations, the voice of another speaker is mixed into the voice of the speaker to be emphasized, so that voice separation for each speaker becomes difficult.

The present disclosure has been made in view of the above-described problems, and an object of the present disclosure is to provide an audio signal processing device or the like capable of extracting a voice of a target speaker even in a situation where a plurality of speakers simultaneously utters.

### Solution to Problem

In view of the above-described problems, an audio signal processing device that is a first aspect of the present disclosure includes:

a determination means configured to determine a first voice section for a target speaker associated with the local device in accordance with an externally acquired first sound signal;

a sharing means configured to transmit the first sound signal and the first voice section to another device associated with a non-target speaker and receive a second sound signal and a second voice section related to the non-target speaker from the another device;

an estimation means configured to estimate a voice of the non-target speaker mixed in the first sound signal in accordance with the received second sound signal and the received second voice section and an acquired estimation parameter related to the target speaker; and

a removal means configured to remove the voice of the non-target speaker from the first sound signal to generate a first post-non-target removal voice.

An audio signal processing method that is a second aspect of the present disclosure includes:

determining a first voice section for a target speaker associated with a local device in accordance with an externally acquired first sound signal;

transmitting the first sound signal and the first voice section to another device associated with a non-target speaker and receiving a second sound signal and a second voice section related to the non-target speaker from the another device;

estimating a voice of the non-target speaker mixed in the first sound signal in accordance with the received second sound signal and the received second voice section and an acquired estimation parameter related to the target speaker; and

removing the voice of the non-target speaker from the first sound signal to generate a first post-non-target removal voice.

An audio signal processing program that is a third aspect of the present disclosure causes a computer to implement:

determining a first voice section for a target speaker associated with a local device in accordance with an externally acquired first sound signal;

transmitting the first sound signal and the first voice section to another device associated with a non-target speaker and receiving a second sound signal and a second voice section related to the non-target speaker from the another device;

estimating a voice of the non-target speaker mixed in the first sound signal in accordance with the received second sound signal and the received second voice section and an acquired estimation parameter related to the target speaker; and

removing the voice of the non-target speaker from the first sound signal to generate a first post-non-target removal voice.

The audio signal processing program may be stored in a non-transitory storage medium.

### Advantageous Effects of Invention

According to the present disclosure, an audio signal processing device or the like capable of extracting a voice of a target speaker even in a situation where a plurality of speakers simultaneously utters can be provided.

### BRIEF DESCRIPTION OF DRAWINGS

FIG. 1 is a block diagram illustrating a configuration example of a sound signal processing device according to a first example embodiment of the present disclosure.

FIG. 2 is a flowchart illustrating an operation example of the sound signal processing device according to the first example embodiment.

FIG. 3 is a diagram illustrating details of an operation of non-target voice estimation by the sound signal processing device according to the first example embodiment.

FIG. 4 is a diagram illustrating details of an operation of non-target voice estimation by the sound signal processing device according to the first example embodiment.

FIG. 5 is a schematic diagram illustrating an implementation situation of the sound signal processing device.

FIG. 6 is a schematic diagram for describing a technique according to PTL 2.

FIG. 7 is a schematic diagram for describing a technique related to the sound signal processing device according to the first example embodiment.

FIG. 8 is a block diagram illustrating a configuration example of a sound signal processing device according to a second example embodiment of the present disclosure.

FIG. 9 is a flowchart illustrating an operation example of the sound signal processing device according to the second example embodiment.

FIG. 10 is a diagram illustrating details of the operation of the sound signal processing device according to the second example embodiment.

FIG. 11 is a diagram illustrating details of the operation of the sound signal processing device according to the second example embodiment.

FIG. 12 is a block diagram illustrating a configuration example of a sound signal processing device according to a third example embodiment.

FIG. 13 is a flowchart illustrating an operation example of the sound signal processing device according to the third example embodiment.

FIG. 14 is a block diagram illustrating a configuration example of a sound signal processing device according to a fourth example embodiment.

FIG. 15 is a block diagram illustrating a configuration example of an information processing device applicable to each example embodiment.

### EXAMPLE EMBODIMENT

Hereinafter, example embodiments will be described in detail with reference to the drawings. In the following description of the drawings, the same or similar parts are denoted by the same or similar reference numerals. Note that the drawings schematically illustrate configurations in the example embodiments of the disclosure. Further, the example embodiments of the disclosure described below are examples, and can be appropriately changed within the same essence.

### First Example Embodiment

(Sound Signal Processing Device)

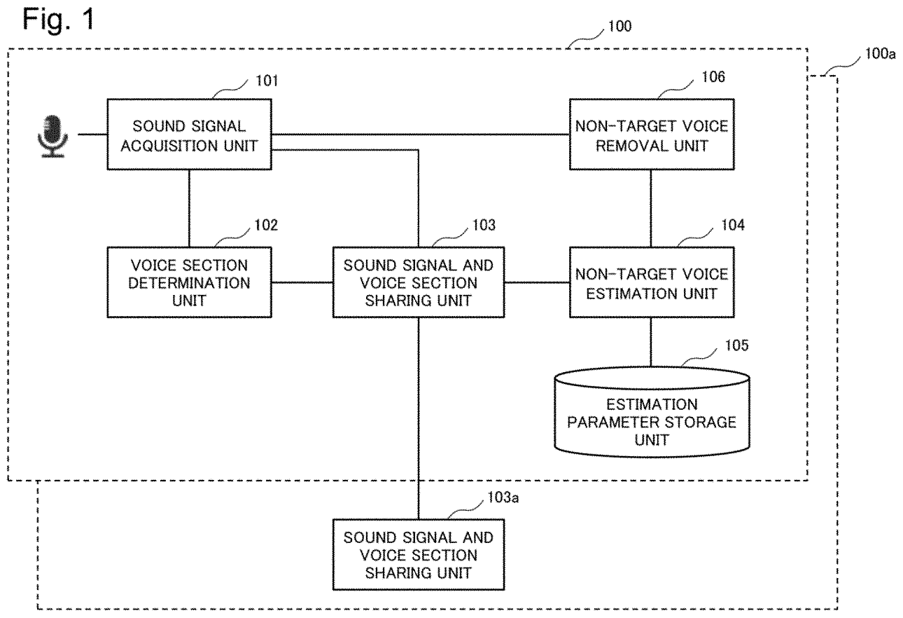

Hereinafter, a first example embodiment of the disclosure will be described with reference to the drawings. FIG. 1 is a block diagram illustrating a configuration example of a sound signal processing device 100 (an audio signal processing device) according to the first example embodiment. There may be a plurality of sound signal processing devices 100, which are referred to as a plurality of signal processing devices 100 and 100a in the present example embodiment. The plurality of signal processing devices 100 and 100a is the same devices and has the same internal configuration. Each sound signal processing device 100 is associated with each target speaker. Each of a plurality of the speakers may own one sound signal processing device 100. The sound signal processing device 100 may be built in a terminal owned by a user.

The sound signal processing device 100 includes a sound signal acquisition unit 101, a voice section determination unit 102, a sound signal and voice section sharing unit 103, a non-target voice estimation unit 104, an estimation parameter storage unit 105, and a non-target voice removal unit 106.

The estimation parameter storage unit 105 stores in advance an estimation parameter related to a target speaker. Details of the estimation parameter will be described below.

The sound signal acquisition unit 101 acquires a sound signal of surroundings using a microphone. One or a plurality of microphones may be provided per device. The sound signal acquisition unit 101 mainly acquires an utterance of a speaker possessing the sound signal processing device 100, but a voice of another speaker or surrounding noise may be mixed. The sound signal is time-series information, and the sound signal acquisition unit 101 converts the sound signal obtained by the microphone from analog data into digital data, for example, into 16-bit pulse code modulation (PCM) data with a sampling frequency of 48 kHz and acquires the converted sound signal. The sound signal acquisition unit 101 transmits the acquired sound signal to the voice section determination unit 102, the sound signal and voice section sharing unit 103, and the non-target voice removal unit 106.

The voice section determination unit 102 determines a voice section (first voice section) of the target speaker associated with the local device on the basis of the sound signal (first sound signal) acquired from the outside. Specifically, the voice section determination unit 102 cuts out a section in which the speaker who possesses the sound signal processing device 100 has uttered from the sound signal acquired from the sound signal acquisition unit 101. For example, the voice section determination unit 102 cuts out data from the time-series digital data every short time with a window width of 512 points and a shift width of 256 points, obtains a sound pressure for each cut out unit, determines the presence or absence of a voice according to whether the sound pressure exceeds a preset threshold value, and determines a section in which the voice continues as a voice section. For the determination of the voice section, an existing method such as a method using a hidden Markov model (HMM) or a method using a long short-term memory (LSTM) can be used in addition to the above method. The voice section is, for example, start time and end time of the utterance of the speaker during a time from the start to the end of a conference. A time from the start time to the end time of the utterance of the speaker may be added to the voice section. Alternatively, the start time and the end time of the utterance of the speaker may be represented by a standard time using a timestamp function or the like of an operation system (OS) that acquires standard time. The voice section determination unit 102 transmits the determined voice section to the sound signal and voice section sharing unit 103.

The sound signal and voice section sharing unit 103 transmits the sound signal (first sound signal) of the local device and the sound section (first voice section) of the local device to another device associated with a non-target speaker, and receives a sound signal (second sound signal) and a sound section (second voice section) related to a non-target speaker from the another device. Specifically, the sound signal and voice section sharing unit 103 communicates with a sound signal and voice section sharing unit 103a of the another sound signal processing device 100a other than the local device, and transmits and receives the sound signal and the voice section to and from each other and shares the sound signals and the voice sections. The sound signal and voice section sharing units 103 may asynchronously broadcast the sound signal and the voice section, or there may be a sound signal processing device 100 serving as a hub and information collected therein may be delivered again. Alternatively, all the sound signal processing devices 100 may transmit the sound signal and the voice section to a server, and a plurality of the sound signals and the sound sections collected on the server side may be distributed to the sound signal processing devices 100 again.

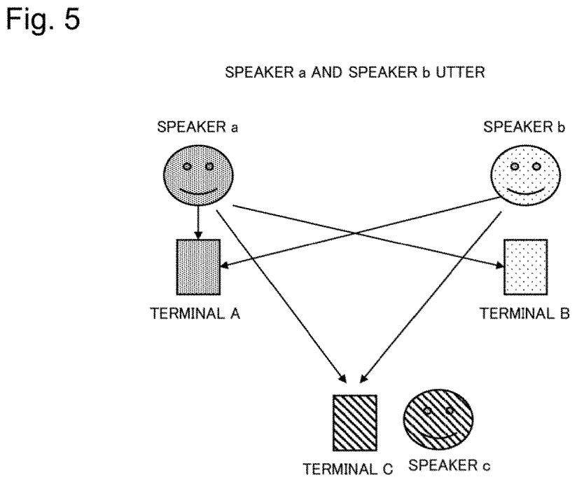

The non-target voice estimation unit 104 acquires information of the sound signal (second sound signal) and the voice section (second voice section) acquired by the another sound signal processing device 100a from the sound signal and voice section sharing unit 103. The non-target voice estimation unit 104 acquires an estimation parameter stored in the estimation parameter storage unit 105. The estimation parameter is, for example, information of an arrival time (time shift) and an attenuation amount until the voice acquired by the another sound signal processing device 100a arrives at the sound signal processing device 100 that is the local device. The non-target voice estimation unit 104 estimates whether the sound signal and the voice section of the another sound signal processing device 100a are of a non-target voice, using the estimation parameter. That is, the non-target voice estimation unit 104 estimates whether the voice acquired by the another sound signal processing device 100a is a sound signal mixed in the voice acquired by the sound signal acquisition unit 101. The non-target voice estimation unit 104 transmits the estimated non-target voice (mixed sound signal) to the non-target voice removal unit 106. As a result of the estimation, the non-target voice estimation unit 104 may determine whether the voice acquired by the another sound signal processing device 100a matches the sound signal mixed in the voice acquired from the sound signal acquisition unit 101. In the present example embodiment, speakers a to c are assumed to be specified as illustrated in FIG. 5, and thus the mixed voice can be easily predicted from the estimation result.

The non-target voice removal unit 106 removes the voice of the non-target speaker from the sound signal (first sound signal) acquired by the local device to generate a post-non-target removal voice (first post-non-target removal voice). Specifically, the non-target voice removal unit 106 acquires the estimated non-target voice from the non-target voice estimation unit 104. The non-target voice removal unit 106 removes the estimated non-target voice from the voice acquired by the sound signal acquisition unit 101. At the time of removal, for example, an existing method such as a spectrum subtraction method of performing short-time fast Fourier transform (FFT), performing division for each frequency band in a spectrum domain, and performing subtraction, or a Wiener filter method of calculating a gain for noise suppression and performing multiplication is used.

(Operation of Sound Signal Processing Device)

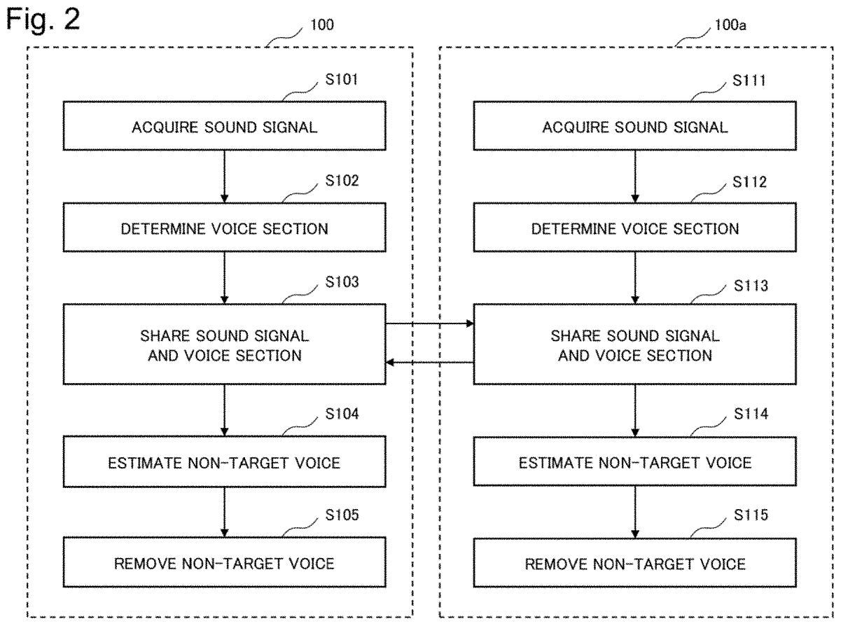

Next, operations of the sound signal processing devices 100 and 100a according to the first example embodiment will be described with reference to the flowchart of FIG. 2. Since the sound signal processing devices 100 and 100 a execute the same operation with the same configuration, processing contents of steps S101 to S105 and steps S111 to S115 are the same. Further, the following description will be given on the assumption that the sound signal processing devices 100 and 100a are mounted on a terminal A and a terminal B such as portable communication terminals possessed by speakers, respectively. In the following description, the terminal A may be referred to as a local terminal A possessed by the target speaker, and the terminal B may be referred to as another terminal B possessed by another speaker.

First, the sound signal acquisition unit 101 acquires the sound signal using the microphone or the like (step S101). In the following processing, the time series of the sound signal may be cut out every short time with the window width of 512 points and the shift width of 256 points, for example, and the processing of step S102 and subsequent steps may be performed. Alternatively, the processing of step S102 and subsequent steps may be sequentially performed for the time series of the sound signal every one second or the like.

Here, n is a sample point (time) of the digital signal, and the sound signal acquired by the terminal A is represented as y_A(n). y_A(n) mainly includes a voice signal x_A(n) of the speaker associated with the terminal A, and has a voice signal x_B(n)′ of the non-target speaker mixed therein. Only x_A(n) is extracted by estimating and removing x_B(n)′ using the following procedure. Similar processing is performed in the terminal B, and only the voice x_B(n) of the speaker associated with the terminal B is extracted.

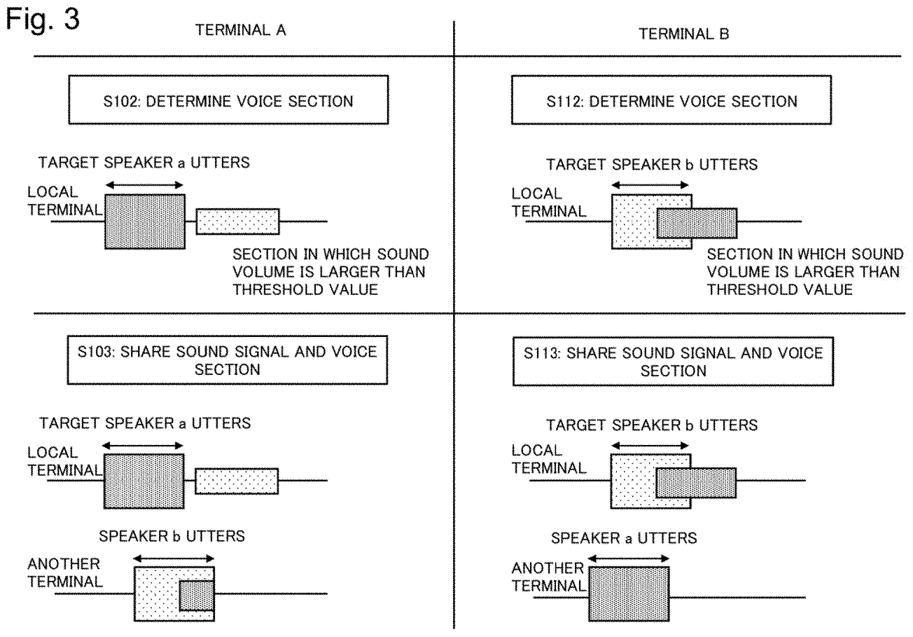

Next, the voice section determination unit 102 cuts out only a section in which the speaker who possesses the terminal A has uttered from the acquired sound signal (step S102). FIG. 3 is a schematic diagram illustrating processing of steps S102 and S103 (steps S112 and S113). A specific example of voice section determination by the terminal A and the terminal B is illustrated in the upper part of FIG. 3. The terminal A is associated with the speaker a as the target speaker and the terminal B is associated with the speaker b as the target speaker, and the terminal A determines the voice section of the speaker a and the terminal B determines the voice section of the speaker b. At this time, for example, a section in which a sound volume is larger than a threshold value is determined as a voice section, and is represented as a rectangle having a long vertical width as illustrated in FIG. 3. At this time, the horizontal width of the rectangle represents the length of the utterance. In the upper part of FIG. 3, the voice section of the speaker a is clear. However, in practice, the sound volume of the voice changes from moment to moment depending on the type of phonemes and the like, and there is a possibility that an error is included if the voice section is uniquely determined only by comparing the magnitude with the threshold value. Therefore, post-processing such as extending the front and rear of the voice section to reduce loss is required. Here, the voice section is represented as VAD[y_A(n)]. When the sound signal y_A(n) at the time n is a voice, the voice section is represented as VAD[y_A(n)]=1, and when the sound signal y_A(n) is a non-voice, the voice section is represented as VAD[y_A(n)]=0.

Next, the sound signal and voice section sharing unit 103 shares the sound signals and the voice sections by transmitting the acquired sound signal and voice section to the another terminal B located in the vicinity and receiving, by the local terminal A, the sound signal and the voice section acquired by the another terminal B (step S103). A lower part of FIG. 3 illustrates a specific example of sharing the sound signals and the voice sections. The terminal A in the lower part acquires the voice acquired by the terminal B and the speech section of the speaker b in addition to the voice acquired by the local terminal and the speech section of the speaker a. On the contrary, the terminal B acquires the voice acquired by the terminal A and the speech section of the speaker a in addition to the voice acquired by the local terminal and the speech section of the speaker b. The same applies to a case where the number of terminals is large, and the number of shares increases in accordance with the number of terminals. Here, the sound signal and the voice section acquired by the terminal A are represented as y_A(n) and VAD[y_A(n)], and the sound signal and the voice section acquired by the terminal B are represented as y_B(n) and VAD[y_B(n)].

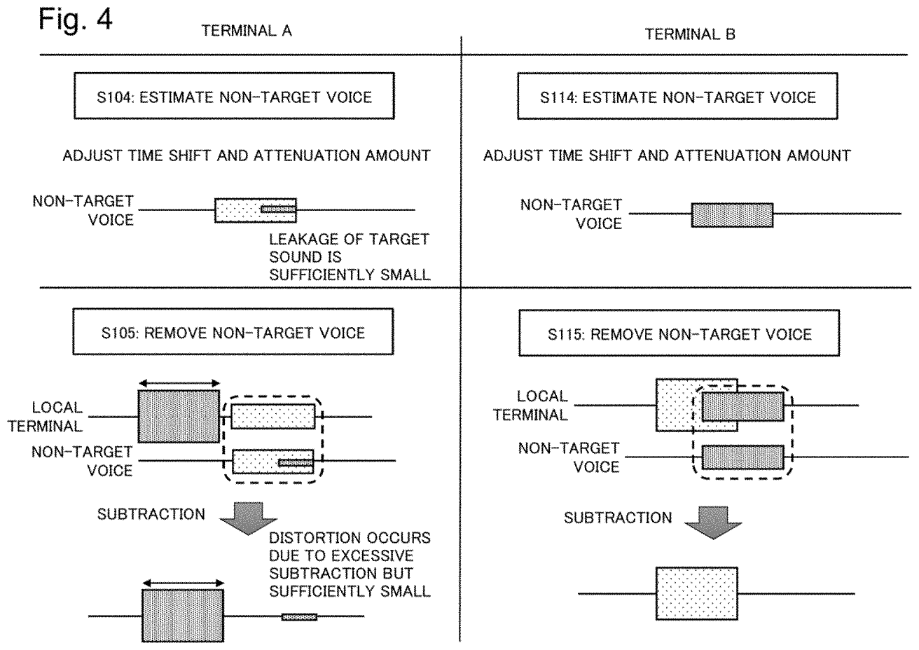

Next, the non-target voice estimation unit 104 estimates the non-target voice mixed in the voice acquired by the local terminal A from the information of the sound signal and the voice section acquired by the another terminal B and the parameter stored in the estimation parameter storage unit 105 (step S104). FIG. 4 is a schematic diagram illustrating processing of steps S104 and S105 (steps S114 and S115). A specific example of the non-target voice estimation by the terminal A and the terminal B is illustrated in the upper part of FIG. 4. The estimation parameter storage unit 105 stores the information of the arrival time (time shift) and the attenuation amount until the voice acquired by the another terminal B arrives at the local terminal A as the estimation parameter, and estimates the non-target voice mixed in the voice acquired by the local terminal A, using the information. For example, the information of the time shift and the attenuation amount can be held in the form of an impulse response. The impulse response is a response to a pulse signal.

In estimating a non-target voice signal in the terminal A (here, a voice signal of the terminal B mixed in the voice acquired by the terminal A), first, an effective voice signal y_b(n)′ is calculated from the shared sound signal y_b(n) and voice section VAD[y_b(n)] of the terminal B according to the equation 1.

y_b(n)′=y_b(n)·VAD[y_b(n)] (Equation 1)

Here, · represents a product. The product is executed at each time n. Next, a non-target voice est_b(n) is estimated by convolving an impulse response h(m). The convolution can be performed using the equation 2.

est_b(n)=Σₘh(m)·y_b(n−m)′ (Equation 2)

Here, m represents the time shift. Referring to the upper left part of FIG. 4, the voice signal of the local terminal A is mixed in the non-target voice signal estimated here, but even in such a case, since the impulse response h(m) is a value smaller than 1, the value is sufficiently smaller than that of the original signal, so that leakage of the target sound is sufficiently small.

Similarly, for a non-target voice signal in the terminal B (here, a voice signal of the terminal A mixed in the voice acquired by the terminal B), first, an effective voice signal y_a(n)′ is calculated from the shared sound signal y_a(n) and voice section VAD[y_a(n)] of the terminal A according to the equation 3.

y_a(n)′=y_a(n)·VAD[y_a(n)] (Equation 3)

Next, the non-target voice est_a(n) is estimated according to the equation 4.

est_a(n)=Σₘh(m)·y_a(n−m)′ (Equation 4)

Next, the non-target voice removal unit 106 removes the estimated non-target voice from the voice acquired by the sound signal acquisition unit 101 (step S105). A specific example of estimating the non-target voice is illustrated in the lower part of FIG. 4. By removing the estimated non-target voice from the sound signal acquired by the local terminal A, only the voice of the target speaker can be extracted. In a case where the target voice is mixed into the estimated non-target voice as illustrated in the lower left of FIG. 4, there is a possibility that distortion occurs due to excessive subtraction, but the distortion is sufficiently small. This influence can be reduced by, for example, providing flooring to the amount to be subtracted and not subtracting a certain value or more, or by performing processing such as adding sufficiently small white noise and masking a value after the subtraction. Alternatively, a Wiener filter method may be used, and in this case, a minimum value of the gain is determined in advance, and processing is performed so that suppression is not performed to or below the value.

Here, as an example, the spectrum subtraction method of performing short-time FFT, performing division for each a frequency band in a spectrum domain, and performing subtraction will be described. It is assumed that Y_a(i, ω) is obtained by applying short-time FFT to the voice signal y_a(n) of the terminal A, and Est_b[i, ω] is obtained by applying short-time FFT to the non-target voice signal est_b(n). Here, i represents an index of a short time window, and ω represents an index of a frequency. By removing the non-target voice signal est_b(n) from Y_a(i, ω), the voice X_a(i, ω) of the speaker associated with the local terminal A is acquired according to the equation 5.

X_a(i,ω)=max[Y_a(i,ω)−Est_b(i,ω),floor] (Equation 5)

Here, max[A, B] represents an operation taking a larger value of A and B. floor represents flooring of the amount to be subtracted, and indicates that the subtraction is not performed to or above this value.

Here, the solution of the problem of PTL 2 made by the disclosure will be described. First, the problem of PTL 2 can be understood as follows.

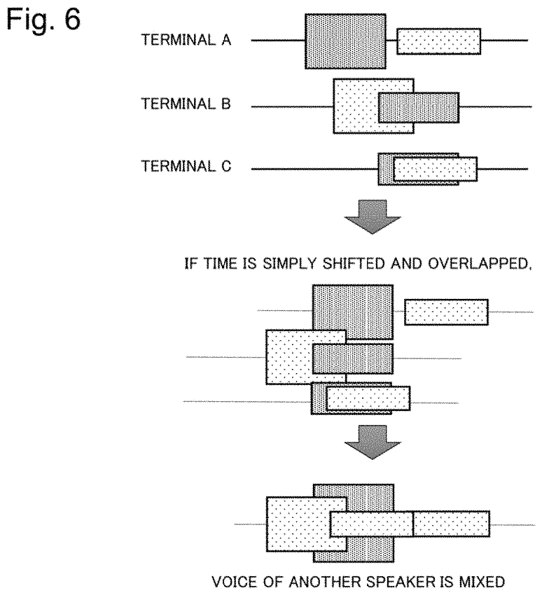

As illustrated in FIG. 5, a case where three speakers a, b, and c respectively own terminals A, B, and C each including a microphone will be described. FIG. 6 illustrates voice extraction processing for each speaker in PTL 2. As illustrated in FIG. 6, two speakers: the speaker a and the speaker b utter almost without a time interval. In this situation, the voice of the speaker a is recorded larger in the terminal A than in the other terminals, and then the voice of the speaker b is recorded. The voice of the speaker b is recorded larger in the terminal B than in the other terminals, and then the voice of the speaker a is recorded. Each voice is recorded in the terminal C. As described above, there may be a terminal that cannot separate the voices in terms of time and records the voices depending on the timing of the two voices. In such a situation, if the time is simply shifted and repeated to emphasize the utterance of the speaker a, the utterance of speaker b is mixed, so that the expected effect cannot be obtained.

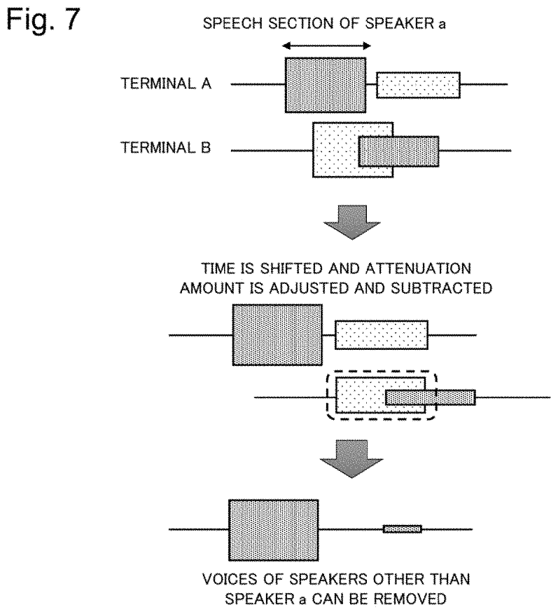

Next, voice extraction processing for each speaker according to the first example embodiment of the disclosure in the situation illustrated in FIG. 5 will be described with reference to FIG. 7. In the sound signal processing device 100 of the first example embodiment, the voice of the speaker a is not emphasized in the terminal A, but the mixture of the voice of the speaker b who is the non-target speaker is estimated and removed using the information of the sound signal and the voice section acquired from the terminal B. By doing so, even in a situation where a plurality of speakers is talking without a time interval, the voice of an individual speaker can be extracted.

Further, here, separation of the voices of the two speakers has been described. However, even when there are three or more speakers, it is possible to extract only the voice of the speaker associated with each of the terminals by estimating a plurality of non-target voices and subtracting the non-target voices by taking a similar procedure.

Thus, the description of the operations of the sound signal processing devices 100 and 100a ends.

### Effects of First Example Embodiment

According to the sound signal processing device 100 of the present example embodiment, the voice of the target speaker can be extracted even in the situation where a plurality of speakers simultaneously utters. This is because the sound signal and voice section sharing units 103 included in the local terminal A and the another terminal B transmit and receive the sound signals and the voice sections to and from each other and share the sound signals and the voice sections. Furthermore, this is because the non-target voice estimation unit 104 estimates the non-target voice mixed in the voice acquired by the local terminal A, using the information of the sound signal and the voice section shared with each other, and the estimated non-target voice is removed from the target voice and the target voice is emphasized.

### Second Example Embodiment

(Sound Signal Processing Device)

In step S105 described above, in the case where the target voice is mixed into the estimated non-target voice as illustrated in the lower left of FIG. 4, there is a possibility that a small distortion occurs due to excessive subtraction and noise is included. In a second example embodiment of the present disclosure, a sound signal processing device that suppresses occurrence of the distortion will be described.

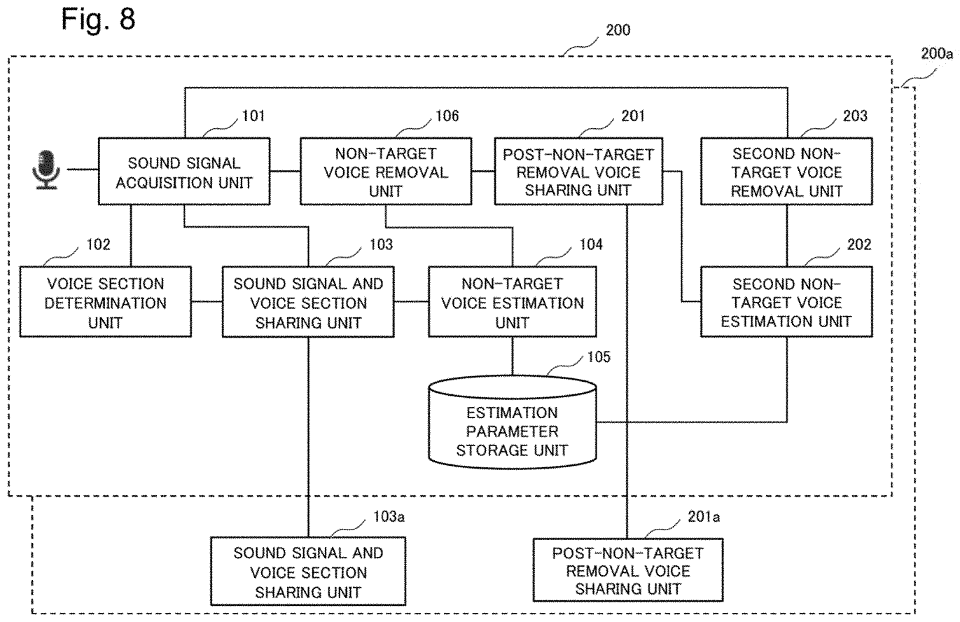

FIG. 8 is a block diagram illustrating a configuration example of a sound signal processing device 200 according to the second example embodiment. The sound signal processing device 200 includes a sound signal acquisition unit 101, a voice section determination unit 102, a sound signal and voice section sharing unit 103, a non-target voice estimation unit 104, an estimation parameter storage unit 105, a non-target voice removal unit 106, a post-non-target removal voice sharing unit 201, a second non-target voice estimation unit 202, and a second non-target voice removal unit 203.

The post-non-target removal voice sharing unit 201 shares a voice after removal of a non-target voice with a post-non-target removal voice sharing unit 201a of another sound signal processing device 200a as a first post-non-target removal voice. The post-non-target removal voice sharing unit 201 transmits the post-non-target removal voice (first post-non-target removal voice) to the another sound signal processing device 200a, and receives a post-non-target removal voice (second post-non-target removal voice) of the another sound signal processing device 200a from the another sound signal processing device 200a. The post-non-target removal voice sharing unit 201 transmits the received post-non-target removal voice to the second non-target voice estimation unit 202.

The second non-target voice estimation unit 202 estimates a voice of a non-target speaker on the basis of the post-non-target removal voice (second post-non-target removal voice) received from the another device and an estimation parameter of the local device. Specifically, the second non-target voice estimation unit 202 receives the post-non-target removal voice (second post-non-target removal voice) of the another sound signal processing device 200a from the post-non-target removal voice sharing unit 201, and acquires the estimation parameter from the estimation parameter storage unit 105. The second non-target voice estimation unit 202 estimates a second non-target voice by adjusting time shift and an attenuation amount of a speech section for the received post-non-target removal voice on the basis of the estimation parameter. The second non-target voice estimation unit 202 transmits the estimated second non-target voice to the second non-target voice removal unit 203.

When acquiring the estimated second non-target voice from the second non-target voice estimation unit 202, the second non-target voice removal unit 203 removes the estimated second non-target voice from the voice acquired by the sound signal acquisition unit 101.

The other parts are similar to those of the first example embodiment illustrated in FIG. 1.

(Sound Signal Processing Method)

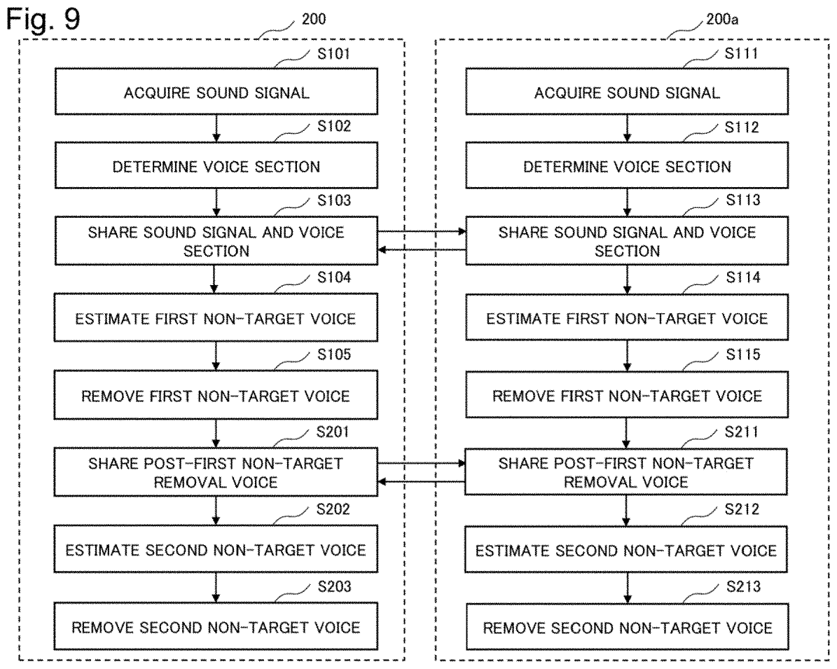

An example of operations of the sound signal processing devices 200 and 200a according to the present example embodiment will be described with reference to the flowchart of FIG. 9.

First, steps S101 to S105 (steps S111 to S115) in FIG. 9 are similar to the steps of the first example embodiment illustrated in FIG. 2.

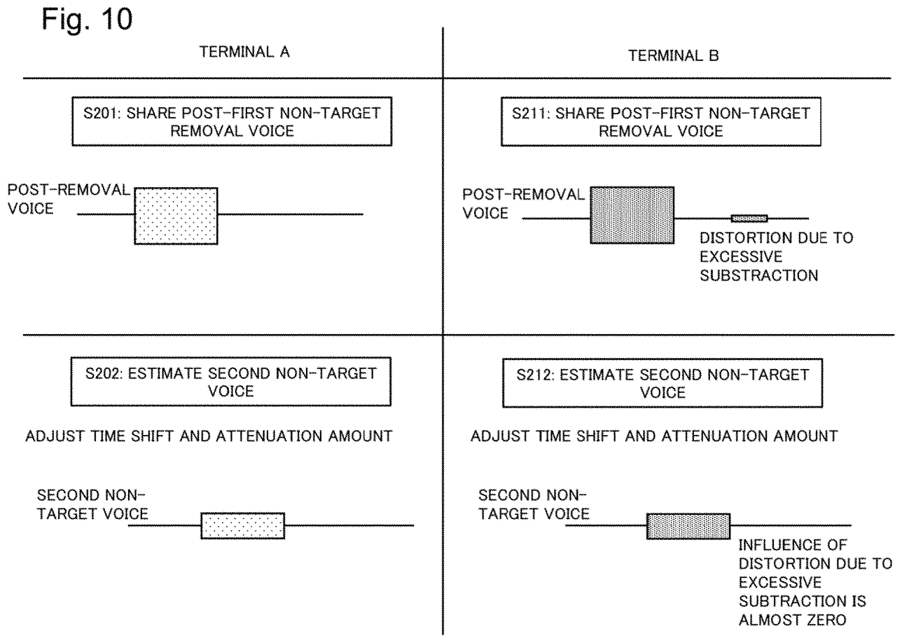

Next, the post-non-target removal voice sharing unit 201 of a local terminal A shares the voice after removal of the non-target voice obtained in step S105 with another terminal B as the first post-non-target removal voice (step S201). FIG. 10 is a schematic diagram illustrating processing of steps S201 and S202 (steps S211 and S212). A specific example of sharing of the first post-non-target removal voice by the terminal A and the terminal B is illustrated in the upper part of FIG. 10.

Next, the second non-target voice estimation unit 202 estimates the second non-target voice by adjusting the time shift and the attenuation amount for the first post-non-target removal voice received from the another terminal B (step S202). A specific example of the second non-target voice estimation of the terminal A and the terminal B is illustrated in the lower part of FIG. 10. The estimation parameter storage unit 105 stores information of arrival time and the attenuation amount until the voice acquired by the another terminal B arrives at the local terminal A as the estimation parameter, and estimates the non-target voice mixed in the voice acquired by the local terminal A, using the information. By estimating the non-target voice mixed in the voice acquired by the local terminal A, using the first post-non-target removal voice, an influence of distortion can be further reduced as compared with the first non-target voice estimation unit 104. This is because the time shift and the attenuation amount are corrected for the distortion caused by excessive subtraction, and thus the influence is further reduced.

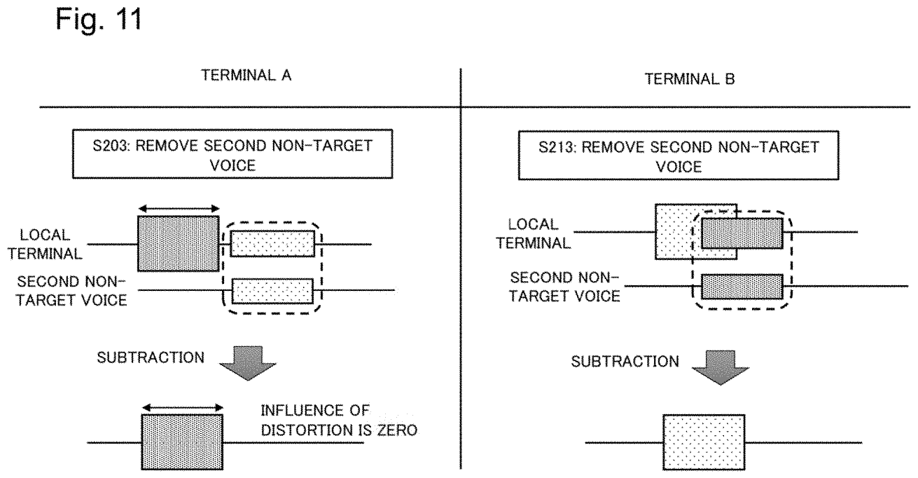

Next, the second non-target voice removal unit 203 removes the estimated second non-target voice from the voice acquired by the sound signal acquisition unit 101 (step S203). FIG. 11 illustrates a specific example of the second non-target voice removal of the terminal A and the terminal B in step S203. By repeating the estimation processing twice as illustrated in FIG. 11, the influence of distortion can be made zero, that is, noise can be removed.

Thus, the description of the operations of the sound signal processing devices 200 and 200a ends.

(Effects of Second Example Embodiment)

According to the sound signal processing device 200 of the present example embodiment, the voice of the target speaker can be accurately extracted even in the situation where a plurality of speakers simultaneously utters. This is because, in addition to the estimation by the non-target voice estimation unit 104 according to the first example embodiment, the post-non-target removal voice is shared with the another terminal B, and the second non-target voice estimation unit 202 adjusts the time shift and the attenuation amount of the speech section for the post-non-target removal voice of the another terminal B, estimates the non-target voice of the second time, and removes the distortion (noise).

### Third Example Embodiment

(Sound Signal Processing Device)

In the sound signal processing devices 100 and 200 according to the first and second example embodiments, the estimation parameter stored in advance in the estimation parameter storage unit 105 has been used. In a third example embodiment of the present disclosure, a sound signal processing device that calculates an estimation parameter and stores the estimation parameter in an estimation parameter storage unit 105 will be described. The sound signal processing device according to the third example embodiment can be used, for example, in a scene where an estimation parameter of a non-target voice is calculated at the beginning of a conference or the like and a target voice is extracted during the conference using the estimation parameter.

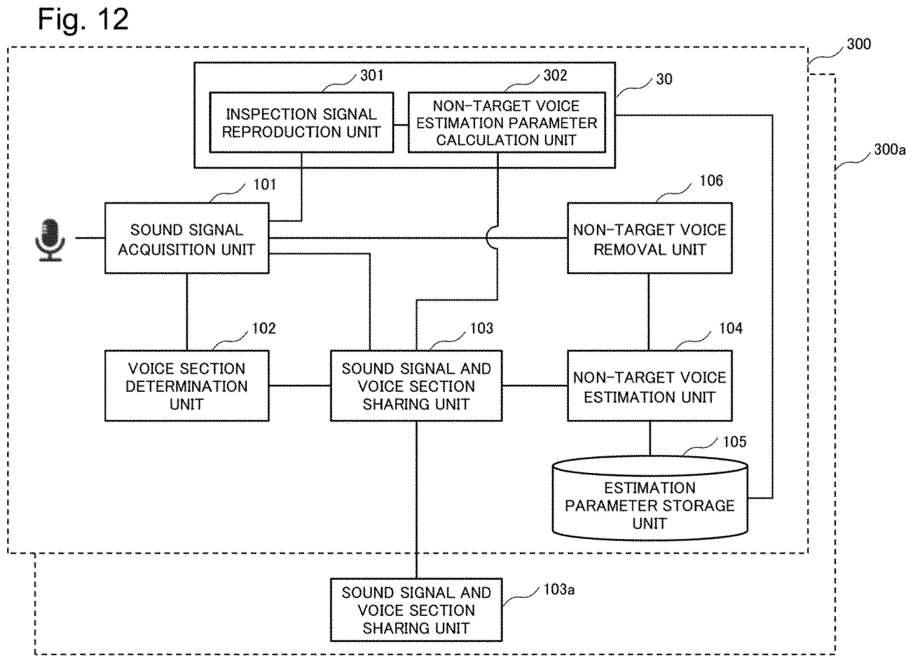

FIG. 12 is a block diagram illustrating a configuration example of a sound signal processing device 300. Hereinafter, for the sake of simplicity of description, description will be given on the assumption that a parameter calculation unit 30 for calculating the estimation parameter is added to the sound signal processing device 100 according to the first example embodiment of FIG. 1, but the parameter calculation unit is also applicable to the sound signal processing device 200 according to the second example embodiment.

As illustrated in FIG. 12, the sound signal processing device 300 includes a sound signal acquisition unit 101, a voice section determination unit 102, a sound signal and voice section sharing unit 103, a non-target voice estimation unit 104, an estimation parameter storage unit 105, a non-target voice removal unit 106, and the parameter calculation unit 30. The parameter calculation unit 30 includes an inspection signal reproduction unit 301 and a non-target voice estimation parameter calculation unit 302.

The inspection signal reproduction unit 301 reproduces an inspection signal. The inspection signal is an acoustic signal used for estimation parameter calculation processing, and may be reproduced from the signal stored in a memory (not illustrated) or the like or may be generated in real time. When the inspection signal is reproduced from the same position as each speaker, the accuracy of estimation is increased. The non-target voice estimation parameter calculation unit 302 receives the inspection signal reproduced by the inspection signal reproduction unit 301. For reception, a microphone for inspection may be used, or a microphone connected to the sound signal acquisition unit 101 may be used. The microphone is preferably disposed near the position of each speaker. The non-target voice estimation parameter calculation unit 302 calculates information serving as the estimation parameter on the basis of the received inspection signal, for example, information of arrival time (time shift) and an attenuation amount until a voice acquired by another sound signal processing device 300a arrives at the sound signal processing device 300 that is a local device. The calculated estimation parameter is stored in the estimation parameter storage unit 105.

Other parts are similar to those of the first example embodiment.

(Parameter Calculation Method)

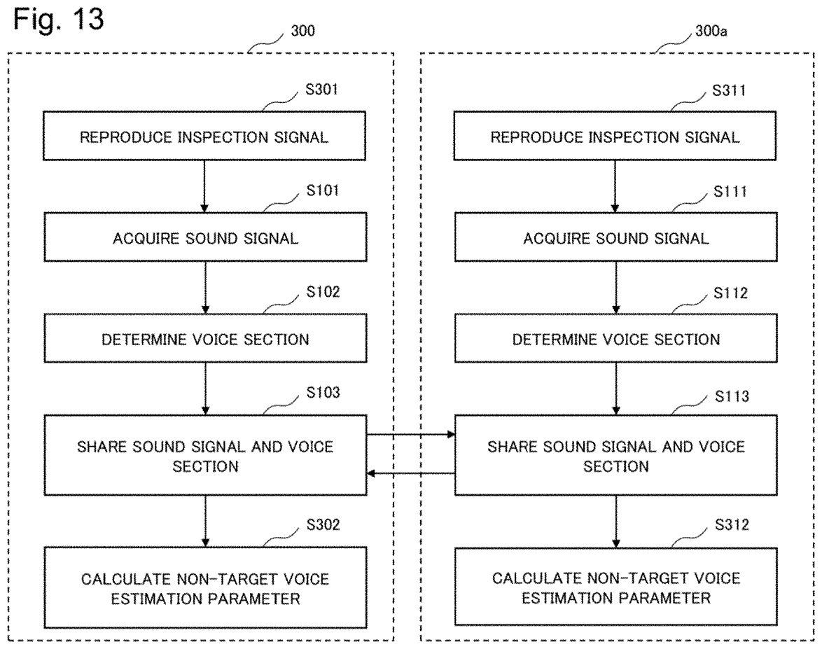

FIG. 13 is a flowchart illustrating an example of estimation parameter calculation processing of the sound signal processing devices 300 and 300a. A plurality of the sound signal processing devices 300 may be present, similarly to the sound signal processing device 100, and description will be given on the assumption that a local terminal A includes the sound signal processing device 300 and another terminal B includes the sound signal processing device 300a. In FIG. 13, steps S301 and S302 are similar to steps S311 and S312, and steps S101 to S103 are similar to steps S111 to S113.

The inspection signal reproduction unit 301 reproduces the inspection signal (step S301). The inspection signal is a substitute for a voice of a speaker targeted by the terminal, and the inspection signal reproduction unit 301 reproduces a known signal at known timing and length. This is to calculate a parameter that enables accurate non-target voice estimation. The inspection signal uses an acoustic signal that is typically used to obtain an impulse response. For example, it is conceivable to use an M-sequence signal, white noise, a sweep signal, a time stretched pulse (TSP) signal, or the like. It is desirable that each of the plurality of terminals A and B reproduces a known and unique signal. This is because the inspection signals can be separated even if the inspection signals are simultaneously reproduced by reproducing the known and unique signals.

Thereafter, similarly to the operation of the first example embodiment, a sound signal is acquired (step S101), a voice section is determined (step S102), and the sound signal and the speech section are shared (step S103).

Next, the non-target voice estimation parameter calculation unit 302 calculates parameters for non-target voice estimation (step S302). As the parameters for non-target voice estimation, there are the time shift and the attenuation amount, and these two amounts can be obtained by calculating the impulse response. As a method of calculating the impulse response, an existing method such as a direct correlation method, a cross spectrum method, or a maximum length sequence (MLS) method is used. Here, an example using the direct correlation method will be described. In the direct correlation method, in a function in which autocorrelation such as white noise is a delta function, calculation is performed using that the correlation function is equivalent to the impulse response. When a time series of an inspection sound is x(n) and the sound signal acquired by a certain terminal is y(n), a cross-correlation function xcorr(m) can be calculated by the following equation 6.

x corr(m)=(1/N)·Σₙx(n)·y(n+m) (Equation 6)

Here, n and m represent sample points (time) of a digital signal, and N represents the number of sample points to be added. The cross-correlation function xcorr(m) represents the magnitude of the attenuation amount at each time. m when the cross-correlation function xcorr(m) is maximum represents the magnitude of the time shift. The equation 6 can be calculated for a combination of terminals A and B. In addition, the cross-correlation function can be more accurately obtained as the number of sample points N to be added is larger. The cross-correlation function can be regarded as an impulse response h(m).

Furthermore, it is also conceivable to calculate not only the parameter for the non-target voice estimation but also a parameter such as a threshold value regarding the voice section determination in the voice section determination unit 102. As for the voice section determination unit, a method of a voice detection device described in PTL 3 may be used.

Thus, the description of the operations of the sound signal processing devices 300 and 300a ends.

(Effects of Third Example Embodiment)

According to the sound signal processing device 300 of the present example embodiment, the voice of the target speaker can be extracted even in the situation where a plurality of speakers simultaneously utters, similarly to the first and second example embodiments. Furthermore, the sound signal processing device 300 can calculate the estimation parameter of the non-target voice at the beginning of a conference or the like, for example, and extract the target voice during the conference using the calculated estimation parameter, thereby extracting a voice with high accuracy in real time.

(Modification)

In the first to third example embodiments, it is assumed that the parameter for non-target voice estimation is calculated using an audible sound, but the parameter may be calculated using an inaudible sound. The inaudible sound is a sound signal that cannot be recognized by humans, and it is conceivable to use a sound signal of equal to or more than 18 kHz, or equal to or more than 20 kHz or more. It is conceivable to calculate the parameter for non-target voice estimation using both an audible sound and an inaudible sound at the beginning of a conference or the like, obtain a relationship between the time shift and the attenuation amount with respect to the audible sound and the time shift and the attenuation amount with respect to the inaudible sound, measure the time shift and the attenuation amount with respect to the inaudible sound using the inaudible sound during the conference, predict the time shift and the attenuation amount with respect to the audible sound from the relationship between the time shift and the attenuation amount with respect to the audible sound and the time shift and the attenuation amount with respect to the inaudible sound, and continue updating.

For example, it is assumed that, at the beginning of the conference, when the time shift of the audible sound until an inspection sound reproduced from a certain terminal is measured by another certain terminal is 0.1 seconds and the attenuation amount is 0.5, the inaudible time shift is 0.1 seconds and the attenuation amount is 0.4, and the inaudible time shift during the conference is 0.15 seconds and the attenuation amount is 0.2. Since the time shift is the same between the audible sound and the inaudible sound, the time shift can be predicted as 0.15 seconds, and since the attenuation amount of the audible sound is 5/4 times the inaudible attenuation amount, the attenuation amount can be predicted as 0.25. In practice, since both the audible sound and the inaudible sound have a range of frequencies, it is necessary to consider a relationship among a plurality of frequencies, and the like. However, it is possible to roughly predict the time shift and the attenuation amount with respect to the audible sound from the time shift and the attenuation amount with respect to the inaudible sound in such a calculation procedure.

### Fourth Example Embodiment

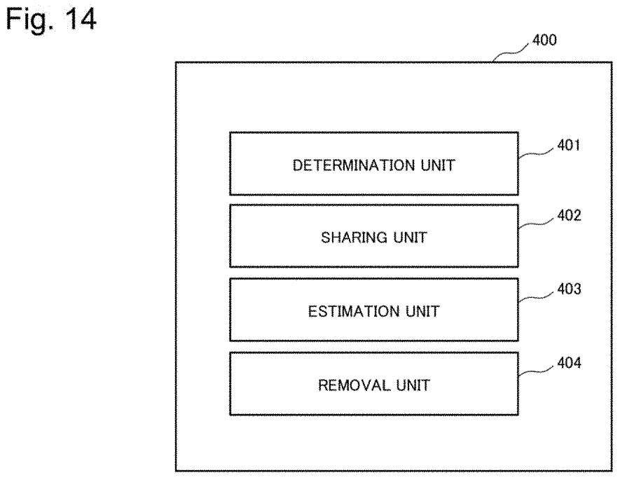

A sound signal processing device 400 according to a fourth example embodiment is illustrated in FIG. 14. The sound signal processing device 400 represents a minimum necessary configuration for implementing the sound signal processing devices according to the first to third example embodiments. A sound signal processing device 400 is provided with: a determination unit 401 that determines a first voice section for a target speaker associated with a local device on the basis of an externally acquired first sound signal; a sharing unit 402 that transmits the first sound signal and the first voice section to another device associated with a non-target speaker and receives a second sound signal and a second voice section related to the non-target speaker from the another device; an estimation unit 403 that estimates the voice of the non-target speaker mixed in the first sound signal on the basis of the received second sound signal and the received second voice section and an acquired estimation parameter; and a removal unit 404 that removes the voice of the non-target speaker from the first sound signal to generate a first post-non-target removal voice.

According to the sound signal processing device 400 of the fourth example embodiment, the voice of the target speaker can be extracted even in the situation where a plurality of speakers simultaneously utters. This is because the sharing units 402 of the local terminal A and the another terminal B both including the sound signal processing device 400 transmit and receive the sound signals and the voice sections to and from each other and share the sound signals and the voice sections. Furthermore, this is because the estimation unit 403 estimates the non-target voice mixed in the voice acquired by the local terminal A, using the information of the sound signal and the voice section shared with each other, and the estimated non-target voice is removed from the target voice.

(Information Processing Device)

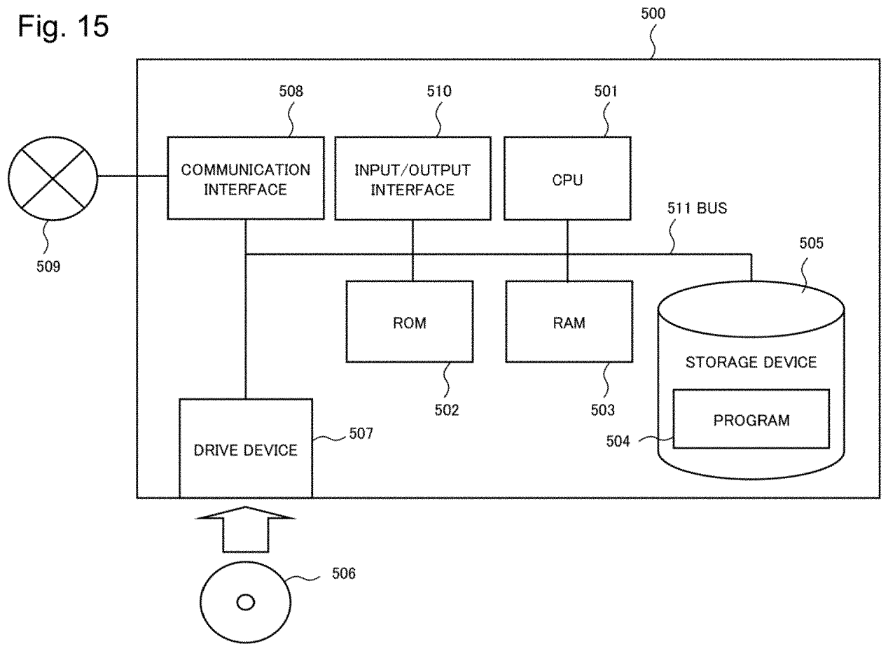

In the above-described example embodiments of the disclosure, some or all of the constituent elements in the sound signal processing devices illustrated in FIGS. 1, 8, and 12, and the like can be implemented using any combination of an information processing device 500 illustrated in FIG. 15 and a program, for example. The information processing device 500 includes, as an example, the following configuration.
A central processing unit (CPU) 501
A read only memory (ROM) 502
A random access memory (RAM) 503
A storage device 505 that stores a program 504 and other data
A drive device 507 that performs read and write with respect to a recording medium 506
A communication interface 508 connected to a communication network 509
An input/output interface 510 that inputs or outputs data
A bus 511 connecting the constituent elements

The constituent elements of the sound signal processing device in each example embodiment of the present application are implemented by the CPU 501 acquiring and executing the program 504 for implementing the functions of the constituent elements. The program 504 for implementing the functions of the constituent elements of the sound signal processing device is stored in advance in the storage device 505 or the RAM 503, for example, and is read by the CPU 501 as necessary. The program 504 may be supplied to the CPU 501 through the communication network 509 or may be stored in the recording medium 506 in advance and the drive device 507 may read and supply the program to the CPU 501. The drive device 507 may be externally attachable to each device.

There are various modifications for the implementation method of each device. For example, the sound signal processing device may be implemented by any combination of an individual information processing device and a program for each constituent element. Furthermore, a plurality of the constituent elements provided in the sound signal processing device may be implemented by any combination of one information processing device 500 and a program.

Further, some or all of the constituent elements of the sound signal processing device are implemented by another general-purpose or dedicated circuit, a processor, or a combination thereof. These elements may be configured by a single chip or a plurality of chips connected via a bus.

Some or all of the constituent elements of the sound signal processing device may be implemented by a combination of the above-described circuit, and the like, and a program.

In the case where some or all of the constituent elements of the sound signal processing device are implemented by a plurality of information processing devices, circuits, and the like, the plurality of information processing devices, circuits, and the like may be arranged in a centralized manner or in a distributed manner. For example, the information processing devices, circuits, and the like may be implemented as a client and server system, a cloud computing system, or the like, in which the information processing devices, circuits, and the like are connected via a communication network.

While the disclosure has been particularly shown and described with reference to the example embodiments thereof, the disclosure is not limited to these example embodiments. It will be understood by those of ordinary skill in the art that various changes in form and details may be made therein without departing from the spirit and scope of the disclosure as defined by the claims.

### REFERENCE SIGNS LIST

100 sound signal processing device
100a sound signal processing device
101 sound signal acquisition unit
102 voice section determination unit
103 voice section sharing unit
103a voice section sharing unit
104 non-target voice estimation unit
105 estimation parameter storage unit
106 non-target voice removal unit
200 sound signal processing device
200a sound signal processing device
201 post-non-target removal voice sharing unit
201a post-non-target removal voice sharing unit
202 second non-target voice estimation unit
203 second non-target voice removal unit
300 sound signal processing device
300a sound signal processing device
301 inspection signal reproduction unit
302 non-target voice estimation parameter calculation unit
400 sound signal processing device
401 determination unit
402 sharing unit
403 estimation unit
404 removal unit
500 information processing device
504 program
505 storage device
506 recording medium
507 drive device
508 communication interface
509 communication network
510 input/output interface
511 bus

What is claimed is:

1. An audio signal processing device comprising:
a memory configured to store instructions; and
at least one processor configured to execute the instructions to:
determine a first voice section for a target speaker associated with the local device in accordance with an externally acquired first sound signal;
transmit the first sound signal and the first voice section to another device associated with a non-target speaker and receive a second sound signal and a second voice section related to the non-target speaker from the another device;
estimate a voice of the non-target speaker mixed in the first sound signal in accordance with the received second sound signal and the received second voice section and an acquired estimation parameter related to the target speaker; and
remove the voice of the non-target speaker from the first sound signal to generate a first post-non-target removal voice.

2. The audio signal processing device according to claim 1, wherein further comprising:
the at least one processor is further configured to execute the instructions to:
transmit the first post-non-target removal voice to the another device and receive a second post-non-target removal voice obtained by removing a voice of the target speaker from the second sound signal from the another device;
estimate the voice of the non-target speaker in accordance with the received second post-non-target removal voice and the estimation parameter; and
remove the voice of the non-target speaker from the first sound signal.

3. The audio signal processing device according to claim 1, wherein
the estimation parameter includes at least one of a time shift or an attenuation amount until the second sound signal reaches the local device.

4. The audio signal processing device according to claim 3, wherein
the time shift and the attenuation amount are calculated in accordance with an impulse response.

5. The audio signal processing device according to claim 1, wherein:
the at least one processor is further configured to execute the instructions to:
reproduce an inspection signal; and
calculate an estimation parameter for estimating a voice of the another device to be mixed from the inspection signal and the first sound signal.

6. The audio signal processing device according to claim 5, wherein
the at least one processor is configured to execute the instructions to:
use an audible sound in the calculation of the estimation parameter.

7. The audio signal processing device according to claim 5, wherein
the at least one processor is configured to execute the instructions to:
use an inaudible sound in the calculation of the estimation parameter.

8. An audio signal processing method comprising:
determining a first voice section for a target speaker associated with a local device in accordance with an externally acquired first sound signal;
transmitting the first sound signal and the first voice section to another device associated with a non-target speaker and receiving a second sound signal and a second voice section related to the non-target speaker from the another device;
estimating a voice of the non-target speaker mixed in the first sound signal in accordance with the received second sound signal and the received second voice section and an acquired estimation parameter related to the target speaker; and
removing the voice of the non-target speaker from the first sound signal to generate a first post-non-target removal voice.

9. A non-transitory storage medium storing an audio signal processing program for causing a computer to implement:
determining a first voice section for a target speaker associated with a local device in accordance with an externally acquired first sound signal;
transmitting the first sound signal and the first voice section to another device associated with a non-target speaker and receiving a second sound signal and a second voice section related to the non-target speaker from the another device;
estimating a voice of the non-target speaker mixed in the first sound signal in accordance with the received second sound signal and the received second voice section and an acquired estimation parameter related to the target speaker; and
removing the voice of the non-target speaker from the first sound signal to generate a first post-non-target removal voice.
